(19) United States
(12) Patent Application Publication
(10) Pub. No.: US 2009/0055347 A1
(43) Pub. Date: Feb. 26, 2009

(54) Wireless Emergency Management Application

(75) Inventors: Andrea Hollman, Seabrook, TX (US); Jon Kocen, Houston, TX (US)

Correspondence Address: GREENBERG TRAURIG, LLP, 2101 L Street, N.W., Suite 1000, Washington, DC, 20037, US

(73) Assignee: United Space Alliance, LLC, Cape Canaveral, FL (US)

(21) Appl. No.: 11/844,496

(22) Filed: Aug. 24, 2007

(51) Int. Cl. G06F 17/30

(52) U.S. Cl. 707/1; 707/E17.001

(57) ABSTRACT

A system and method for providing a wireless emergency management application that facilitates the identification of persons who have various skills and/or training, thereby allowing the best available person to respond to an emergency or non-emergency situation. Still further, the instant system and method can track the location of specialized equipment, thereby allowing the equipment to be more readily employed when needed. The instant system and method can also wirelessly distribute EAP-related information, such as, without limitation, a role definition and a checklist to be followed in performing the tasks associated with that role, for each responder in a particular emergency response. As the responder responds to the emergency, his or her responses can be transmitted back to a centralized server for dissemination to and coordination with other users.

The invention described herein was made in the performance of work under NASA Contract No. NAS9-20000 and is subject to the provisions of Section 305 of the National Aeronautics and Space Act of 1958 (42 U.S.C. § 2457).

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD

The instant disclosure relates generally to the field of emergency management, and more particularly provides an infrastructure which facilitates emergency response coordination and information dissemination.

### BACKGROUND

During an emergency situation, personnel, equipment, and other resources must be assembled and efficiently allocated. In a well organized emergency response, management and support personnel follow an Emergency Action Plan (“EAP”) which outlines tasks that are to be completed and steps to follow to complete the tasks, tailored to the current type of emergency.

Many larger organizations publish binders full of EAPs, each targeted to a specific type of emergency. These EAPs frequently set forth a checklist which is to be followed during the emergency response, thereby helping to streamline the emergency response and to ensure that the proper techniques are used to respond to the emergency. Many organizations distribute EAPs in paper form, thereby allowing the responder to simply tear out the appropriate page(s) from an EAP binder and follow the checklist.

### SUMMARY

Increased personnel and equipment specialization has led to more interdependency and a need for more communication between different units. Additionally, complex emergency situations require frequent progress updates so that managing personnel can quickly reallocate their resources in response to changing conditions.

In some embodiments, the instant system and method provides a wireless emergency management application that facilitates the identification of persons who have various skills and/or training, thereby allowing the best available person to respond to the emergency. Still further, the instant system can track the location of specialized equipment, thereby allowing the equipment to be more readily employed when needed. The instant system can also wirelessly distribute EAP-related information, such as, without limitation, a role definition and a checklist to be followed in performing the tasks associated with that role, for each responder in a particular emergency response. As the responder responds to the emergency, his or her responses can be transmitted back to a centralized server, which can coordinate dissemination of those responses to other responders.

Some embodiments comprise a plurality of electronic records stored in a database, wherein each of the electronic records represents a checklist, wherein each checklist comprises a plurality of steps, and wherein each step has associated therewith at least a completion date time stamp and a list of assigned users; computer program process code stored on computer readable media and executable by a processor running on a first computing device, wherein the computer program process code comprises instructions implementing an administrator interface, wherein the administrator interface allows a administrator interface user to initiate a situation, wherein the situation comprises at least one checklist step, and wherein each checklist step is assigned to at least one user; computer program process code stored on computer readable media and executable by a processor running on a second computing device comprising instructions implementing a responder interface, wherein the responder interface receives and displays situation notifications and updates thereto from a wireless emergency management application, wherein the responder interface displays checklist steps assigned to a user of the second computing device, wherein the responder interface receives and stores updated checklist information from the user; and, computer program process code stored on computer readable media and executable by a processor running on a third computing device, wherein the computer program process code comprises instructions implementing the wireless emergency management application, wherein the third computing device is communicatively coupled to the first and second computing devices, wherein the wireless emergency management application transmits a situation notification to the responder interface associated with each user assigned to the situation, wherein the situation notification comprises a situation description and checklist steps assigned to the user, and wherein the wireless emergency management application receives checklist step updates from the responder interface, wherein the checklist step updates are stored in the database, and wherein the wireless emergency management application transmits received checklist step updates to each user assigned to the situation. The first computing device and the third computing device may comprise the same device. The second computing device may be communicatively coupled with the third computing device via a wireless connection. At least one of the checklist steps may be required. At least one of the checklist steps may be optional. At least one of the checklist steps may be a child step. At least one of the checklist steps may require the user to input additional date prior to the step being completed. The administrator interface may require the administrator interface user to enter credentials prior to permitting the administrator interface user to initiate a situation. An automated event can be triggered by the completion of a checklist step.

Some embodiments comprise computer program process code stored on computer readable media, the computer program process code executable by a processor and comprising instructions for providing an administrator interface on a first computing device; providing a responder interface on a second computing device; providing a wireless emergency management application on a third computing device; receiving via the administrator interface situation input from the user, wherein the situation input comprises at least one checklist, wherein each checklist comprises a plurality of steps, and wherein each step has associated therewith at least a completion date time stamp and a list of assigned users; transmitting the situation input from the administrator interface to the responder interface through the wireless emergency management application; receiving situation notifications and updates thereto from the wireless emergency management application via the responder interface and displaying the situation notifications and updates thereto on the responder interface; displaying checklist steps assigned to a user of the second computing device via the responder interface; receiving updated checklist data from the user of the second computing device via the responder interface and storing the updated checklist data on the second computing device; and, transmitting the updated checklist data from the responder interface to the wireless emergency management application. The first computing device and the third computing device can comprise the same device. The second computing device can be coupled to the third computing device via a wireless connection. At least one checklist step can be a required step. At least one checklist step can be an optional step. At least one checklist step can be a child step. The user can be required to input additional data prior to the completion of a checklist step. The transmission of checklist steps can be limited to users associated with the checklist step. Credentials may need to be requested and authenticated prior to the administrator interface permitting an administrator interface user to initiate a situation. At least one automated event may be triggered by the completion of a checklist step.

Additional features and advantages of the invention will be set forth in the description which follows, and in part will be apparent from this disclosure, or may be learned by practice of the invention. The objectives and other advantages of the invention will be realized and attained by the structure particularly pointed out in this written description, including any claims contained herein and the appended drawings.

It is to be understood that both the foregoing general description and the following detailed description are exemplary and explanatory and are intended to provide further explanation of the disclosed wireless emergency management application.

### BRIEF DESCRIPTION OF THE DRAWINGS

The accompanying drawings, which are included to provide a further understanding of the disclosed wireless emergency management application and are incorporated in and constitute a part of this specification, illustrate various embodiments and, together with the description, serve to explain the principles of at least one embodiment of the disclosed wireless emergency management application.

In the drawings:

FIG. 1 is a block diagram illustrating an exemplary process flow according to various embodiments.

FIG. 2 is an exemplary screen capture of a situation display according to various embodiments.

FIG. 3 is an exemplary screen capture of a delegation display according to various embodiments.

FIG. 4 contains exemplary screen captures of a responder interface according to various embodiments.

FIG. 5 contains exemplary screen captures of a responder interface according to various embodiments.

FIG. 6 is a diagram illustrating a wireless emergency management application according to various embodiments.

### DETAILED DESCRIPTION

In some embodiments, the instant system facilitates the dissemination of information during an emergency situation (hereinafter referred to as a “situation” or an “emergency”), and coordinates monitoring and updating of information entered by and provided to various personnel involved in the emergency response. Although described herein as an emergency response system, the instant system can be readily adapted for use in non-emergency communications and task management scenarios as well.

Some embodiments of the instant system are designed for use by larger organizations such as, but not limited to, defense contractors, governmental agencies, municipal first responders, colleges, organizations occupying larger campuses, or the like. In the instant system, each person in an organization who is involved in responding to an emergency situation is assigned a role. Although described herein as each person having a specific role such as, without limitation, firefighter or hazardous materials cleanup coordinator, the role a given person plays can vary across the variety of emergency situations defined within the instant system. That is, although a person may be a firefighter in response to one emergency situation, that person may play the role of state emergency responder liaison in another emergency situation. The instant system can provide a layer of abstraction between individual users and their roles, such that as employees join or leave the organization, roles can easily be assigned to appropriate employees. In some embodiments, a person may be simultaneously involved in more than one situation. In some embodiments, the instant system can track employee attendance and dynamically reassign roles based on employee expertise and availability for each emergency.

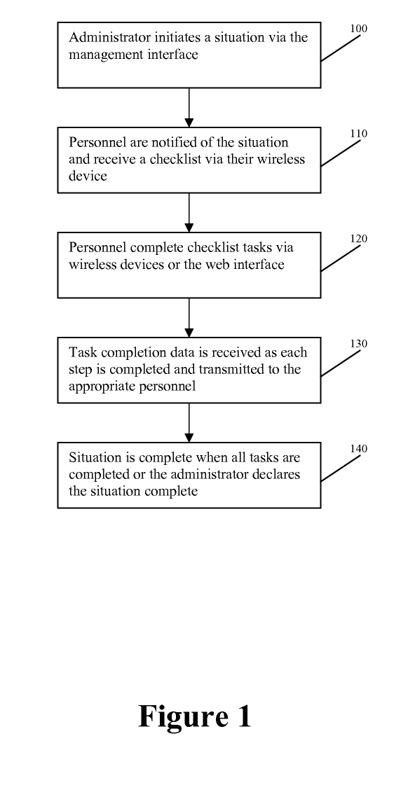

In some embodiments, the core of the instant system can be summarized as employing five basic steps. FIG. 1 is a block diagram illustrating an exemplary process flow for such an embodiment.

In block 100, a user initiates a situation via a administrator interface. In some embodiments, the administrator interface may limit situation initiation to users with administrator or other high-level privileges. The administrator interface can provide access to a wireless emergency management server via a convenient, easy to use interface that allows a situation description to be entered and which also allows the user to select one or more checklists to be associated with the situation. The administrator interface can also allow the user to select a generic situation response plan to be followed by responders, the user can select from one of a plurality of specially tailored situation response plans, or the user can create a new response plan.

In some embodiments, each response plan can include one or more checklists, process steps, tasks, or the like (referred to herein collectively as “checklists”) for each role in the response plan. As discussed above, situation specific checklists may also be associated with default personnel that will be notified or utilized as responders based on their experience, training, or other such background information. In some embodiments, the administrator interface can allow the user initiating a situation, or another user with appropriate privileges, to reassign roles or to assign multiple responders to a given role.

In some embodiments, the administrator interface can be provided as a webpage which may be viewed using a browser. The administrator interface may be provided by a standalone webpage or be integrated into a pre-existing webpage. A checklist area can be provided to allow a user to view checklists assigned to different personnel or departments. However, the administrator interface can also allow the user to arrange the checklists according to a variety of criteria, including, but not limited to, severity of an associated situation, how frequently the checklists are used, situation type, alphabetical order, or the like.

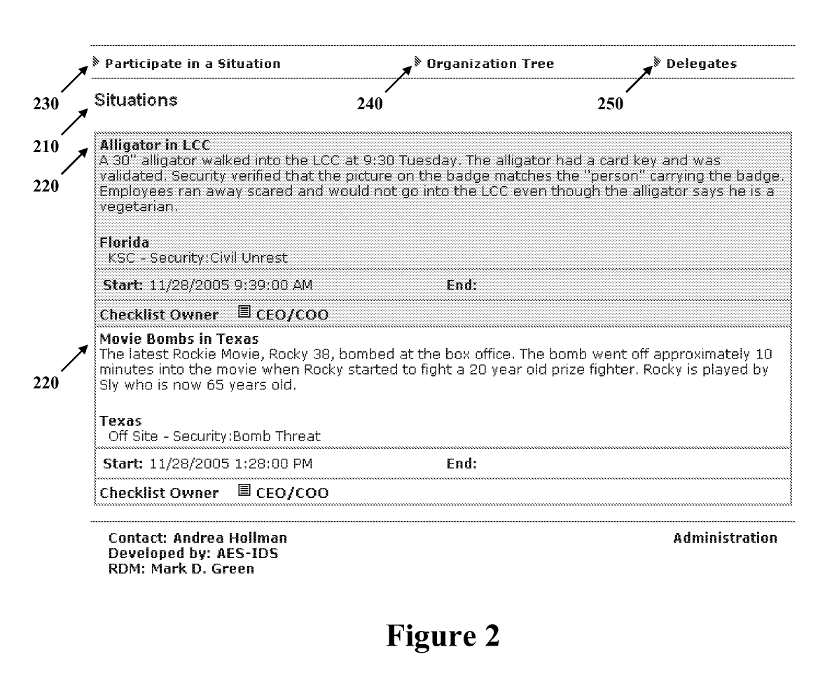

In some embodiments, the administrator interface allows a user to view all emergencies on a single situation screen, such as the exemplary situation display illustrated in FIG. 2. The situation screen provides a situations list 210, a situation area 220 for each active situation, a link to participate in a situation 230, a link to view an organization tree 240, and a link to view and assign delegates 250.

Situations list 210 provides a situation description area 220 for each active situation. Situations list 210 can display all active situations within an organization, or may be filtered by one or more criteria, such as, but not limited to, location, situation category, or situation severity. Situation description area 220 can display similar information to the information displayed in notification area 210, or situation description area 220 can display additional information over that which is displayed in notification area 210.

Participate in a situation link 230 can allow a user to transition from taking a passive role in an active situation to taking an active role. By way of example, a user in a senior role may wish to complete a task for his subordinate, a site manager may deem that certain checklist tasks do not need to be completed, or the site manager may complete them himself.

By clicking or otherwise interacting with view an organization tree link 240, a user to view various organization information. The organization information may be specific to an active situation, specific to a location, or may comprise the entire organization.

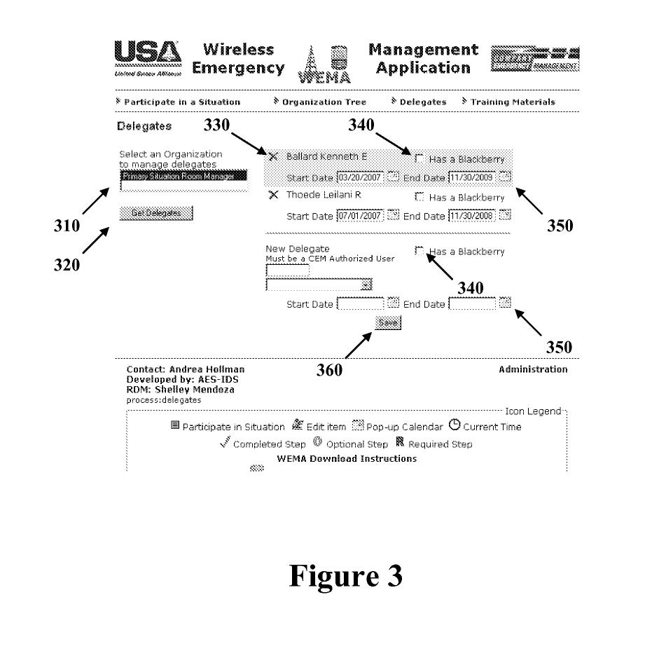

By clicking or otherwise interacting with view assigned delegates link 250, a user can view any delegation of roles that has occurred in an active situation, such as the exemplary delegation display illustrated in FIG. 3. The delegation display provides an organization list 310, organization selection button 320, a delegate delete button 330, a wireless device checkbox 340, an effective date selection area 350, and a save button 360.

Organization list 310 displays a list of available organizations to which the user has adequate permissions to manage delegates. Organization selection button 320 allows a user to select an organization, causing the delegation display to display the delegates associated with the selected organization. For each delegate, the delegation display displays the name of the delegate as well as delegate delete button 330, wireless device checkbox 340, and effective date selection area 350.

Delegate delete button 330 allows the user to delete a delegate from the selected organization. Wireless device checkbox 340 allows the user to select whether a delegate has a wireless device. If wireless device checkbox 340 is checked, the wireless emergency management application will attempt to communicate with the delegate via an assigned wireless device. Effective date selection area 350 allows the user to determine the time frame in which a selected delegate will be granted delegate status for the selected organization. By way of example, without limitation, a supervisor may set effective date selection area 350 for a week period, two months in the future, to coincide with a pre-planned vacation, during which the supervisor will be out of communication range. Save button 360 finalizes and commits any changes made on the delegation display.

In block 110, the wireless emergency management application server notifies the personnel who are assigned to roles in the chosen situations. Such notification may include, but is not limited to, pushing a checklist corresponding to the individual's role to a wireless device assigned to the user. Suitable wireless devices include, but are not limited to wireless text paging devices such as the BlackBerry Pearl, BlackBerry Curve, and BlackBerry 7280 models sold by Research in Motion of Waterloo, Ontario, Canada; cellular phones such as the Treo 755p model sold by Palm, Inc. of Sunnyvale, Calif.; and Personal Digital Assistants (“PDAs”) such as the iPaq model sold by Hewlett-Packard Company of Palo Alto, Calif.; and the like. The notification may be displayed on the wireless device by a responder interface.

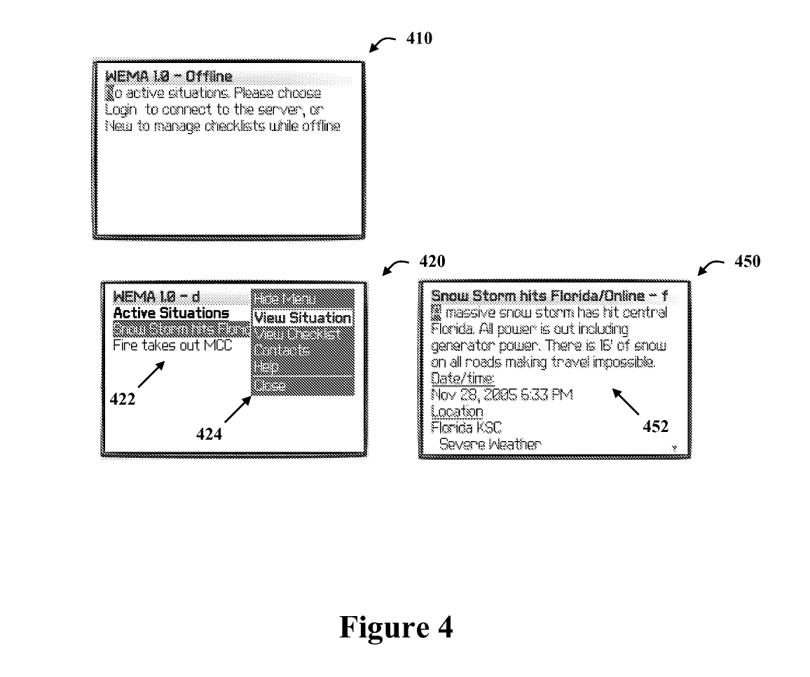

FIG. 4 contains exemplary screen captures of aspects of a responder interface, as a user interacts therewith on a wireless device. Responder interface 410 illustrates a generic user interface that may be presented to a user when the responder interface is initiated on a wireless device. Responder interface 410 may require that the user enter a username and password, biometric identifier, or other such credential before allowing the user to access the instant system.

Once the user has been granted access to the system, the wireless device can display an interface similar to that of responder interface 420. Responder interface 420, can present a list of currently active situations to the user, such as those illustrated in situation list 422. The user can utilize interface menu 424 to obtain additional information about a situation, access a checklist corresponding to the user's role in the selected situation, access the checklist of one or more subordinates, access a contact list of responders or others associated with the selected situation, obtain assistance using the responder interface, and the like. By way of example, without limitation, when a user elects to view information about a situation, the user may be presented with an interface similar to that illustrated by responder interface 450. In responder interface 450, the responder interface is displaying a more detailed description 452 of the selected situation. The description may include additional metadata, such as the date and time the description was last updated, the location(s) impacted by the situation, and the like. Similarly, in some embodiments, the user may initiate a telephone call to another person participating in the active situation from within the responder interface utilizing the contacts.

Referring again to FIG. 1, in block 120, individual personnel record their progress in a responder interface as they complete checklist tasks. In some embodiments, the responder interface can be provided on a wireless device. In the event a responder does not have access to a wireless device, the responder interface can be provided by any networked device capable of running a browser, such as, but not limited to a personal computer. In some embodiments, a user may delegate their tasks to another user, thereby allowing the other user to complete the tasks. When such delegations are made, the tasks can automatically be added to the delegatee's checklist. Such delegations may be prioritized by the delegator, or based on a comparison of the criticality of the delegated task to those already in the delegatee's checklist.

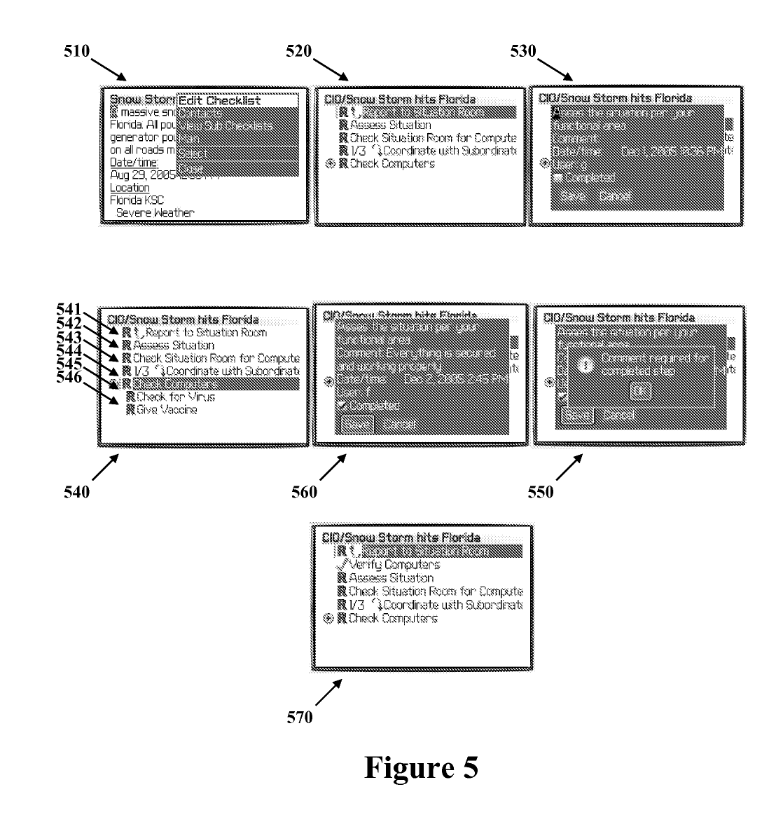

FIG. 5 provides exemplary screen captures of a responder interface as a user interacts with a checklist. In responder interface 510, the responder interface is displaying a situation and a context menu. The context menu allows a user to perform different functions, including editing a checklist, viewing contacts, and viewing sub checklists.

In responder interface 520, the responder interface is displaying a checklist. The checklist contains five required steps which are denoted by an ‘R’. Step 541 is a linked child step. Step 544 has three linked child steps, none of which have been completed. Step 545 has two sub steps 546. In some embodiments, all sub steps are required to be completed before the parent step can be marked complete. In responder interface 530, step 545 has been expanded to show the two sub steps 546 associated with it. In responder interface 530, the user must check computers for a virus and then give the computers a vaccine before step 545 can be completed.

In responder interface 540, the user is attempting to complete the “Assess Situation” step. In responder interface 550, the responder interface will not allow the user to complete the step without entering a comment. In some embodiments, the responder interface may require a user to enter data, including or in lieu of a comment. By way of example, if the user tried to complete the “Give Vaccine” step in responder interface 530, the user may be required to enter the number of computers that were given the vaccine.

In responder interface 560, the user has entered a comment for the “Assess Situation” step. In responder interface 570, the responder interface has accepted the user's input and marked the step as complete.

In some embodiments, the responder interface can facilitate access to information to assist a user in completing a step or sub step, such as, but not limited to, written descriptions, still images, audio, video, or the like.

Steps within one responder's checklist may be dependent on steps within another responder's checklist. By way of example, without limitation, in a power outage situation, personnel from various departments may be responders. A member of the information technology (“IT”) department may be tasked with restarting database servers. However, the IT member may not be allowed restart the database servers until a member of the facilities department completed restoring power to the facility.

Referring again to FIG. 1, in block 130, the responder interface updates the instant system when a task or child step is completed. Such updates can be accomplished through a variety of means including, without limitation, initiating a data push. In the event that a wireless device loses communication with the instant system or is otherwise unreachable, the wireless device can store the updated checklist in a local volatile or non-volatile memory and update the checklist when the wireless device is back is able to re-establish communications with the instant system. Upon receipt of the updated checklist, the wireless emergency management application server logs the updated checklist and pushes it or corresponding information to the wireless devices of appropriate personnel. Additionally, in some embodiments, the data contained in the updated checklist may cause the instant system to trigger automated events, such as, but not limited to, enabling or disabling building facilities or locking or unlocking doors.

In the event that a wireless device loses communication with the instant system or is otherwise unreachable, the device will attempt to re-establish communication with the instant system by sending periodic pings. In some embodiments, attempts to re-establish communication may depend upon device parameters such as signal strength, battery power, or a combination thereof. By way of example, a wireless device may not attempt to re-establish communications if the signal strength is lower than 60% and the battery power is greater than 80%. If the battery power drops below 80%, the device may not attempt to re-establish communications until the signal strength is greater than 70%. Once communication has been re-established, the wireless device will receive the updated checklist from the instant system.

In block 140, the situation is completed when all of the tasks associated with the situation are completed or when the administrator declares the situation complete. Completion of the situation can cause the wireless devices of responders to remove the associated checklist(s) and/or other such information from the wireless device.

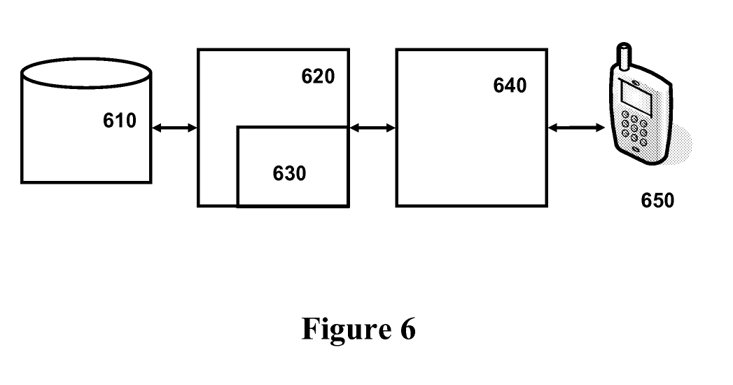

In some embodiments, such as that illustrated in FIG. 6, wireless emergency management application 630 may be provided by a web application server 620. Suitable web application servers may include, but are not limited to, Internet Information Services (“IIS”) distributed by Microsoft Corporation of Redmond, Wash. or Apache HTTP Server distributed by the Apache Software Foundation.

Wireless emergency management application 630 stores data in database 610. The data stored in database 610 may include, but is not limited to, checklists, contact information, situation information, timestamps for completed checklist tasks, and additional task data collected when a user completes a task. Database 610 may be provided by web application server 620, or another server. Suitable databases may include, but are not limited to, Microsoft Access or Microsoft SQL Server sold by Microsoft Corporation of Redmond, Wash., Oracle Database sold by Oracle Corporation of Redwood Shores, Calif., or MySQL available from MySQL Inc. of Cupertino, Calif. Communication between wireless emergency management application 630 and database 610 may occur over a secure or non-secure, private or non-private network.

A user can utilize any networked device (not shown) capable of running a world wide web browsing application (referred to herein as a “browser”), such as, but not limited to, a personal computer, to connect to web application server 620. Such access may be provided via a variety of means including, without limitation, high-speed wired and wireless communications employing the 802.11 series of standards published by the Institute of Electrical and Electronics Engineers (“IEEE”), cellular telephony, digital data encoded by modulating an analog telephone carrier signal using a modem, or the like. In addition, some or all parts of such communications may be secured using a variety of secure communications methods including, without limitation, Virtual Private Networking (“VPN”), Secure Sockets Layer (“SSL”), the Advanced Encryption Standard (“AES”), Triple Data Encryption Standard (“3DES”), or the like.

Web application server 620 can provide a administrator interface to the networked device through which a user can initiate a situation. As discussed above, the administrator interface can also allow the user to view active situations, view and modify checklists in accordance with various criteria, update personnel roles, manage documents, manage contacts, manage flowcharts and perform other such management functions. The administrator interface may also allow the user to delegate roles to alternate personnel.

Wireless device server 640 provides a data connection between web application server 620 and wireless device 650. Such a connection can be provided over a private or non-private network such as, but not limited to, the Internet and may employ one or more encryption or other security means. Wireless device server 640 can also provide a data connection between application server 620 and wireless device 650 through one or more firewalls. Data sent over the connection between web application server 620, through wireless device server 640, to wireless device 650, may be sent in Hypertext Markup Language (“HTML”), Wireless Markup Language (“WML”), eXtensible Markup Language (“XML”), or other markup languages and may be encrypted or otherwise secured. In some embodiments, wireless device server 640 may comprise a BlackBerry™ Enterprise Server with Mobile Data Service. In some embodiments, web application server 620 may further comprise wireless device server 640.

Web application server 620 can provide one or more responder interfaces to wireless device 650 through the connection provided by wireless device server 640 or via a networked device. The responder interface may be provided to personnel via their assigned wireless devices so that they can be alerted to new situations in any location and so that they are free to move while completing their checklist tasks. However, it may be advantageous to allow a user to also access an appropriate responder interface via a networked device if the user's wireless device is inoperable, unable to establish communications with the instant system, or if a role has been assigned to a user who does not have access to a wireless device.

In some embodiments, wireless emergency management application 630 may initiate communication with wireless device 650 via a “push.” The push may be, but is not limited to, a Hypertext Transfer Protocol (“HTTP”) Server Push, a Wireless Application Protocol (“WAP”) Push, or via the transfer of information using Short Message Service (“SMS”). For example, wireless emergency management application 630 may send push data to wireless device 650 to notify the user with which wireless device 650 is associated that a new situation has become active. In the example given, the pushed data might include information about the situation, such as a short description, a description of the user's role, a checklist assigned to the user, photographs, maps or other such visual aids of advantage to the user, and the like.

In some embodiments, the push can begin by wireless emergency management application 630 posting an HTTP request to wireless device server 640 via web application server 620. Wireless device server 640 can respond to web application server 620 with an acknowledgement and queue the push for forwarding to wireless device 650 in a markup language, such as, but not limited to, XML or WML. Web application server 620 posts a result page to wireless emergency management application 630 after receipt of the acknowledgement from wireless device server 640.

In some embodiments, wireless device 650 can respond to the push from wireless emergency management application 630 by sending an acknowledgement to wireless device server 640, which alerts wireless emergency management application 630 that wireless device 650 received the push. In the event that wireless device server 640 does not receive an acknowledgement from wireless device 650, wireless device server 640 may respond according to the nature of the push. By way of example, if the push comprised a general announcement of low importance, wireless device server 640 may do nothing. Alternatively, wireless device server 640 may attempt to re-send the push once or a number of times. The interval between attempts and the number of attempts can be changed based upon the severity of the situation, and the criticality of the information. Wireless device server 640 may also send the push to the wireless device of another user if the original receiving wireless device fails to acknowledge the push after a pre-configured number of attempts.

In some embodiments, wireless device 650 may initiate communication with wireless emergency management application 630 via a push. The push may be, but is not limited to, an (“HTTP”) Server Push, a WAP Push, or an SMS message. For example, wireless device 650 may send a push to wireless emergency management application 630, via wireless device server 640, in the form of a data request or a save option. The save option may be a notification to wireless emergency management application 630 that a task has been completed. In the case that wireless device 650 is notifying wireless emergency management application 630 that a task has been completed, the push may include, but is not limited to, a timestamp denoting when the task was completed, the checklist associated with the completed task, the user who completed the task, and any additional data collected when the task was completed. Wireless device server 640 forwards the push from wireless device 650 to wireless emergency management application 630. If the push was a data request, wireless device server 640 responds to wireless device 650 with the requested data from wireless emergency management application 630 if the user has the requisite permissions. If the push was a save option, wireless device server 640 responds to wireless device 650 with an acknowledgement and wireless emergency management application 630 logs the data in database 610. Wireless emergency management application 630 may then initiate a push to other wireless devices associated with the situation for which the save option was received. In the event that wireless device 650 does not receive an acknowledgement to a save option, it may attempt to re-send the save option at set intervals.

While detailed and specific embodiments of the wireless emergency management application have been described herein, it will be apparent to those skilled in the art that various changes and modifications can be made therein without departing from the spirit and scope of the disclosed wireless emergency management application. Thus, it is intended that the present disclosure cover these modifications and variations provided they come within the scope of any appended claims and/or their equivalents.

What is claimed is:

1. A system comprising:
a plurality of electronic records stored in a database, wherein each of the electronic records represents a checklist, wherein each checklist comprises a plurality of steps, and wherein each step has associated therewith at least a completion date time stamp and a list of assigned users;
computer program process code stored on computer readable media and executable by a processor running on a first computing device, wherein the computer program process code comprises instructions implementing an administrator interface, wherein the administrator interface allows a administrator interface user to initiate a situation, wherein the situation comprises at least one checklist step, and wherein each checklist step is assigned to at least one user;
computer program process code stored on computer readable media and executable by a processor running on a second computing device comprising instructions implementing a responder interface, wherein the responder interface receives and displays situation notifications and updates thereto from a wireless emergency management application, wherein the responder interface displays checklist steps assigned to a user of the second computing device, wherein the responder interface receives and stores updated checklist information from the user; and,
computer program process code stored on computer readable media and executable by a processor running on a third computing device, wherein the computer program process code comprises instructions implementing the wireless emergency management application, wherein the third computing device is communicatively coupled to the first and second computing devices, wherein the wireless emergency management application transmits a situation notification to the responder interface associated with each user assigned to the situation, wherein the situation notification comprises a situation description and checklist steps assigned to the user, and wherein the wireless emergency management application receives checklist step updates from the responder interface, wherein the checklist step updates are stored in the database, and wherein the wireless emergency management application transmits received checklist step updates to each user assigned to the situation.

2. The system of claim 1, wherein the first computing device and the third computing device comprise the same device.

3. The system of claim 1, wherein the second computing device is communicatively coupled to the third computing device via a wireless connection.

4. The system of claim 1, wherein at least one of the checklist steps is a required step.

5. The system of claim 1, wherein at least one of the checklist steps is an optional step.

6. The system of claim 1, wherein at least one of checklist steps is a child step.

7. The system of claim 1, wherein at least one of the checklist steps requires the user to input additional data prior to the step being completed.

8. The system of claim 1, wherein the checklist step updates are transmitted only to users associated with a checklist step.

9. The system of claim 1, wherein the administrator interface requires the administrator interface user to enter credentials prior to permitting the administrator interface user to initiate a situation.

10. The system of claim 1, wherein at least one automated event is triggered by the completion of a checklist step.

11. Computer program process code stored on computer readable media, the computer program process code executable by a processor and comprising instructions for:
providing an administrator interface on a first computing device;
providing a responder interface on a second computing device;
providing a wireless emergency management application on a third computing device;
receiving via the administrator interface situation input from the user, wherein the situation input comprises at least one checklist, wherein each checklist comprises a plurality of steps, and wherein each step has associated therewith at least a completion date time stamp and a list of assigned users;
transmitting the situation input from the administrator interface to the responder interface through the wireless emergency management application;
receiving situation notifications and updates thereto from the wireless emergency management application via the responder interface and displaying the situation notifications and updates thereto on the responder interface;
displaying checklist steps assigned to a user of the second computing device via the responder interface;
receiving updated checklist data from the user of the second computing device via the responder interface and storing the updated checklist data on the second computing device; and,
transmitting the updated checklist data from the responder interface to the wireless emergency management application.

12. Claim 11, wherein the first computing device and the third computing device comprise the same device.

13. Claim 11, wherein the second computing device is communicatively coupled to the third computing device via a wireless connection.

14. Claim 11, wherein at least one of the checklist steps is a required step.

15. Claim 11, wherein at least one of the checklist steps is an optional step.

16. Claim 11, wherein at least one of checklist steps is a child step.

17. Claim 11, further comprising requiring the user to input additional data prior to the completion of a checklist step.

18. Claim 11, further comprising limiting the transmission of checklist steps to users associated with a checklist step.

19. Claim 11, further comprising requesting and authenticating credentials from a administrator interface user prior to permitting the administrator interface user to initiate a situation.

20. Claim 11, further comprising triggering at least one automated event by completing a checklist step.
